(19) United States
(12) Patent Application Publication
(10) Pub. No.: US 2025/0079639 A1
(43) Pub. Date: Mar. 6, 2025

(54) SECONDARY BATTERY

(71) Applicant: Prime Planet Energy & Solutions, Inc., Tokyo (JP)

(72) Inventor: Harunari SHIMAMURA, Toyonaka-shi (JP)

(21) Appl. No.: 18/811,768

(22) Filed: Aug. 22, 2024

(30) Foreign Application Priority Data
Sep. 1, 2023 (JP) 2023-141946

(51) Int. Cl. H01M 50/483; H01M 50/103; H01M 50/119; H01M 50/342; H01M 50/474

(52) U.S. Cl. CPC H01M 50/483; H01M 50/103; H01M 50/119; H01M 50/3425; H01M 50/474

(57) ABSTRACT

The present disclosure provides a secondary battery including a battery case, an electrode body, and an insulating film that is disposed between the battery case and the electrode body. The insulating film includes a first metal layer formed of a first metal and a second metal layer disposed on a side of the battery case relative to the first metal layer and formed of a second metal with a linear expansion coefficient higher than that of the first metal, and at least a surface of the insulating film that faces the battery case and a surface of the insulating film that faces the electrode body are covered with an insulating material.

### CROSS REFERENCE TO RELATED APPLICATION

This application claims the benefit of priority to Japanese Patent Application No. 2023-141946 filed on Sep. 1, 2023. The entire contents of this application are hereby incorporated herein by reference.

### BACKGROUND OF THE DISCLOSURE

### 1. Field

The present disclosure relates to a secondary battery.

### 2. Background

A secondary battery typically includes a battery case and an electrode body that is accommodated in the battery case. Conventional technical literatures related to secondary batteries include WO 2013/027296 and Japanese Patent Application Publication No. 2022-148731. For example, WO 2013/027296 discloses a secondary battery including a battery case and an electrode body and additionally including an insulating film made of synthetic resin therebetween.

### SUMMARY

According to the present inventor's examination, when the temperature in a battery increases due to overcharging or the like, an insulating film made of synthetic resin such as polypropylene (PP) partially melts in some cases. Thus, in a part where the insulating film has melted, the heat in the battery easily conducts to the battery case, which may result in local heat concentration. As a result, a hole may be opened in the battery case. Furthermore, the content of the secondary battery (for example, a fragment of an active material layer or the like) may be discharged to the outside through the hole part and scatter to the periphery.

The present disclosure has been made in view of the above circumstances, and an object is to provide a secondary battery in which local heat concentration on a battery case is suppressed and a hole is not opened easily in the battery case.

The present disclosure provides a secondary battery including a battery case, an electrode body that is accommodated in the battery case, and an insulating film that is disposed between the battery case and the electrode body. The insulating film includes a first metal layer formed of a first metal and a second metal layer disposed on a side of the battery case relative to the first metal layer and formed of a second metal with a linear expansion coefficient higher than that of the first metal, and at least a surface of the insulating film that faces the battery case and a surface of the insulating film that faces the electrode body are covered with an insulating material.

In the present disclosure, since the linear expansion coefficient of the second metal layer is relatively high, the conduction of the heat from the first metal layer on the electrode body side to the second metal layer on the battery case side causes the second metal layer to expand largely. Along with this expansion, the heat also transfers and accordingly, the heat can be diffused in a wide range. As a result, the local heat concentration on the battery case can be suppressed and opening of the hole in the battery case can be suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a secondary battery according to one embodiment;

FIG. 2 is a perspective view in which the secondary battery in FIG. 1 is inverted in an up-down direction;

FIG. 3 is a longitudinal cross-sectional view schematically illustrating an internal structure of the secondary battery in FIG. 1;

FIG. 4 is a perspective view schematically illustrating an electrode body attached to a sealing plate;

FIG. 5 is a cross-sectional view schematically illustrating a structure of an insulating film according to one embodiment;

FIG. 6 is a development view of the insulating film according to one embodiment;

FIG. 7 is a perspective view schematically illustrating a cooling plate according to one embodiment; and

FIG. 8 is a perspective view schematically illustrating an arrangement example of the cooling plates.

### DETAILED DESCRIPTION OF THE PREFERRED EMBODIMENTS

Some embodiments of the art disclosed herein will hereinafter be described in detail with reference to the drawings. Matters that are other than matters particularly mentioned in the present specification and that are necessary for the implementation of the art disclosed herein (for example, the general configuration and manufacturing process of a secondary battery that do not characterize the art disclosed herein) can be grasped as design matters of those skilled in the art based on the prior art in the relevant field. The art disclosed herein can be implemented on the basis of the contents disclosed in the present specification and common technical knowledge in the relevant field. Note that in the drawings below, the members and parts with the same operation are explained by being denoted by the same reference sign.

In the present specification, “secondary battery” refers to a general electrical energy storage device capable of being repeatedly charged and discharged by transfer of charge carriers between a positive electrode and a negative electrode through an electrolyte. In the present specification, the notation “A to B” for a range signifies a value more than or equal to A and less than or equal to B, and is meant to encompass also the meaning of being “more than A” and “less than B”.

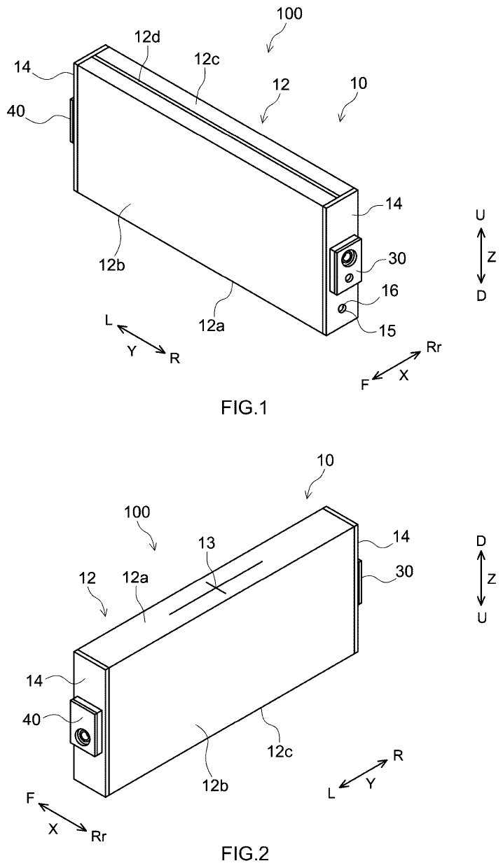

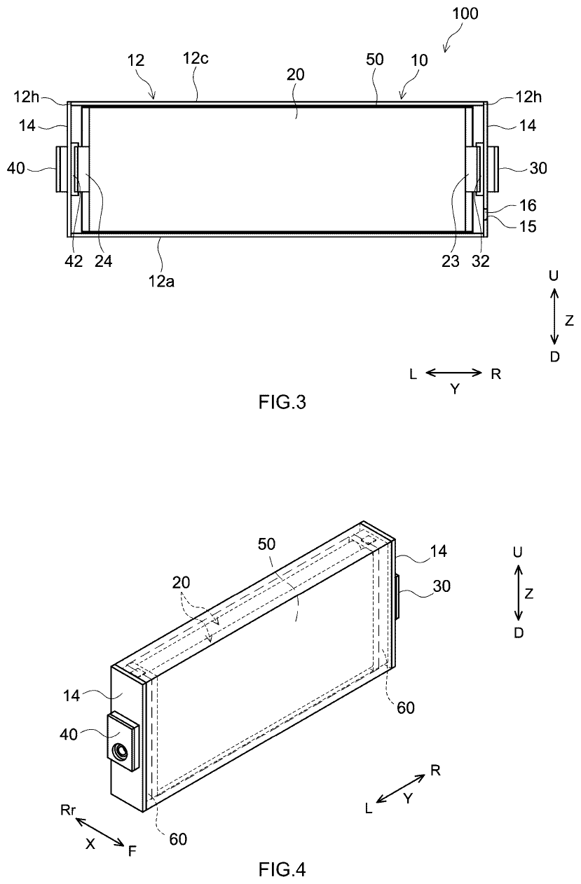

FIG. 1 is a perspective view of a secondary battery 100 according to one embodiment. FIG. 2 is a perspective view in which the secondary battery 100 in FIG. 1 is inverted in an up-down direction. FIG. 3 illustrates an internal structure of the secondary battery 100 in FIG. 1. In the following description, reference signs L, R, F, Rr, U, and D in the drawings respectively denote left, right, front, rear, up, and down, and reference signs X, Y, and Z in the drawings respectively denote a short side direction of the secondary battery 100, a long side direction that is orthogonal to the short side direction, and an up-down direction that is orthogonal to the short side direction and the long side direction. However, these are merely directions determined for convenience of description and do not limit the mode of installation of the secondary battery 100.

As illustrated in FIG. 3, the secondary battery 100 includes a battery case 10, an electrode body 20, a positive electrode terminal 30, a negative electrode terminal 40, and an insulating film 50. Although the illustration is omitted, the secondary battery 100 further includes an electrolyte solution here. The secondary battery 100 is a lithium ion secondary battery here. The secondary battery 100 is preferably the lithium ion secondary battery. The secondary battery 100 is characterized by including the insulating film 50 disclosed herein and the other structures may be similar to the conventional ones.

The battery case 10 is a housing that accommodates the electrode body 20, the insulating film 50, and the electrolyte solution. As illustrated in FIG. 1 and FIG. 2, the battery case 10 has an outer shape that is a flat bottomed cuboid shape (square shape) here. The battery case 10 preferably has a square shape. The material of the battery case 10 may be similar to the conventionally used material without particular limitations. The battery case 10 is preferably made of metal, and more preferably aluminum, an aluminum alloy, iron, an iron alloy, or the like, for example.

As illustrated FIG. 3, the battery case 10 includes a case main body 12 having a pair of openings 12h, and two sealing plates 14 that cover the pair of openings 12h here. The battery case 10 is integrated in such a way that the sealing plates 14 are bonded (for example, bonded by welding) to peripheral edges of the pair of openings 12h of the case main body 12. The battery case 10 is hermetically sealed (closed).

The case main body 12 has a rectangular cylindrical shape, and as illustrated in FIG. 1, includes a bottom surface 12a with an approximately rectangular shape, a pair of long side surfaces 12b extending from long sides of the bottom surface 12a and facing each other, and a top surface 12c connecting upper end parts of the pair of long side surfaces 12b. The top surface 12c has an approximately rectangular shape. The top surface 12c faces the bottom surface 12a. The case main body 12 is formed by, for example, bending one sheet of metal plate into a tubular shape and bonding (for example, bonding by welding) a joint. Here, a welding bonding part 12d exists on the top surface 12c. The bottom surface 12a includes a gas exhaust valve 13.

The gas exhaust valve 13 is configured to fracture when pressure inside the battery case 10 reaches a predetermined value or more and discharge a gas in the battery case 10 to the outside. Although one gas exhaust valve 13 is provided in this embodiment, two or more gas exhaust valves 13 may be provided. Moreover, although the gas exhaust valve 13 is provided on the bottom surface 12a in this embodiment, the gas exhaust valve 13 may be provided on other surface than the bottom surface 12a, for example the long side surface 12b, the top surface 12c, the sealing plate 14, or the like in another embodiment. The area of the gas exhaust valve 13 may be determined arbitrarily.

In this embodiment, the gas exhaust valve 13 is a cross-shaped notch. However, the shape of the gas exhaust valve 13 is not limited in particular. In another embodiment, the gas exhaust valve 13 may be, for example, a linear (only longitudinal line or lateral line) notch, a conventionally known elliptical valve (with a notch inside) or circular valve (with a notch inside), or the like. The size (length, depth) of the notch is arbitrarily set and can be determined as appropriate in consideration of the pressure resistance or the like of the battery case 10, for example.

The sealing plate 14 is a plate-shaped member that seals the opening 12h. The sealing plate 14 has an approximately rectangular shape in a plan view. The area of the sealing plate 14 is smaller than that of the long side surface 12b. The sealing plate 14 includes a liquid injection hole 15. The liquid injection hole 15 is used to inject the electrolyte solution into the battery case 10 after the sealing plate 14 is assembled to the case main body 12. The liquid injection hole 15 is sealed with a sealing member 16 after the electrolyte solution is injected. Although the liquid injection hole 15 is provided at the sealing plate 14 in this embodiment, the liquid injection hole 15 may alternatively be provided at the case main body 12 in another embodiment. In addition, although the liquid injection hole 15 is provided on a surface different from that of the gas exhaust valve 13 in this embodiment, the liquid injection hole 15 may alternatively be provided on the same surface as that of the gas exhaust valve 13 in another embodiment.

The positive electrode terminal 30 and the negative electrode terminal 40 are fixed to the battery case 10. The positive electrode terminal 30 and the negative electrode terminal 40 are fixed to surfaces (specifically, sealing plates 14) of the battery case 10 facing each other here. Specifically, the positive electrode terminal 30 is attached to the sealing plate 14 that is disposed on one side in the long side direction Y (right side in FIG. 1 and FIG. 2). The negative electrode terminal 40 is attached to the sealing plate 14 that is disposed on the other side in the long side direction Y (left side in FIG. 1 and FIG. 2). Although the positive electrode terminal 30 and the negative electrode terminal 40 are provided at the sealing plate 14 in this embodiment, the positive electrode terminal 30 and the negative electrode terminal 40 may alternatively be provided at the case main body 12 in another embodiment. In addition, although the positive electrode terminal 30 and the negative electrode terminal 40 are provided on the surfaces different from that of the gas exhaust valve 13 in this embodiment, the positive electrode terminal 30 and the negative electrode terminal 40 may alternatively be provided on the same surface as that of the gas exhaust valve 13 in another embodiment.

Each of the positive electrode terminal 30 and the negative electrode terminal 40 is exposed to an outer surface of the sealing plate 14. Here, the positive electrode terminal 30 and the negative electrode terminal 40 are disposed on an axial line extending in the long side direction Y and passing a center of the sealing plate 14. However, the axial line may alternatively deviate from the center of the sealing plate 14 to, for example, the short side direction X in another embodiment. Further alternatively, the positive electrode terminal 30 and the negative electrode terminal 40 may be disposed off the axial line. For example, one of the positive electrode terminal 30 and the negative electrode terminal 40 may deviate to one side in the short side direction X and the other may deviate to the other side in the short side direction X.

The positive electrode terminal 30 is preferably made of metal and more preferably made of aluminum or an aluminum alloy, for example. The negative electrode terminal 40 is preferably made of metal and more preferably made of copper or a copper alloy, for example.

As illustrated in FIG. 3, the positive electrode terminal 30 is electrically connected to a positive electrode 23 of the electrode body 20 through a positive electrode current collecting part 32 inside the battery case 10. The negative electrode terminal 40 is electrically connected to a negative electrode 24 of the electrode body 20 through a negative electrode current collecting part 42 inside the battery case 10. The positive electrode terminal 30 and the negative electrode terminal 40 are insulated from the case main body 12 by the insulating film 50. The positive electrode terminal 30 and the negative electrode terminal 40 are insulated from the sealing plate 14 by an insulating member 60 (see FIG. 4).

The electrode body 20 is accommodated inside the battery case 10. FIG. 4 is a perspective view of the electrode body 20 attached to the sealing plate 14. As illustrated in FIG. 4, the electrode body 20 is disposed inside the battery case 10 while being covered with the insulating film 50 to be described below. In this embodiment, a plurality of (two in FIG. 4) electrode bodies 20 are accommodated in one battery case 10. However, the number of electrode bodies 20 to be accommodated in one battery case 10 is not limited in particular and may be three or more, or one in another embodiment.

The electrode body 20 includes the positive electrode 23 and the negative electrode 24 as illustrated in FIG. 3. The electrode body 20 is a wound electrode body here. Specifically, the electrode body 20 is formed in such a way that a multilayer body in which the positive electrode 23 with a band shape and the negative electrode 24 with a band shape are stacked through a separator with a band shape is wound in the long side direction using a winding axis as a center. In another embodiment, however, the electrode body 20 may be a stack type electrode body formed in such a way that a square positive electrode and a square negative electrode are stacked in the insulated state.

The electrode body 20 has a flat outer shape here. The electrode body 20 includes a pair of curved parts and a pair of flat surfaces coupling the pair of curved parts. Here, the electrode body 20 is accommodated inside the battery case 10 with the winding axis extending along the long side direction Y. The electrode body 20 is a so-called lateral winding type. The pair of curved parts of the electrode body 20 face the bottom surface 12a and the top surface 12c of the case main body 12. The pair of flat surfaces of the electrode body 20 face the pair of long side surfaces 12b of the case main body 12. However, the electrode body 20 may alternatively be accommodated inside the battery case 10 with the winding axis extending along the up-down direction Z, for example. The electrode body 20 may be a so-called a longitudinal winding type. The respective members (positive electrode, negative electrode, separator, and the like) included in the electrode body 20 may be similar to those of the general secondary battery without particular limitations.

The positive electrode 23 typically includes a positive electrode current collector, and a positive electrode active material layer fixed on at least one surface of the positive electrode current collector. The positive electrode current collector has a band shape here. The positive electrode current collector is formed of a conductive metal such as aluminum, an aluminum alloy, nickel, or stainless steel. The positive electrode current collector is a metal foil here, specifically an aluminum foil.

The positive electrode active material layer is provided to have a band shape along a longitudinal direction of the positive electrode current collector with a band shape. The positive electrode active material layer includes a positive electrode active material that is capable of reversibly storing and releasing charge carriers. As the positive electrode active material, an oxide containing at least one kind of Ni, Co, and Mn is preferable, and examples thereof include lithium-transition metal complex oxides such as lithium cobaltate, lithium manganate, lithium nickelate, a lithium-nickel-manganese complex oxide, and a lithium-nickel-cobalt complex oxide. It is preferable that the positive electrode active material include, for example, a lithium-nickel complex oxide containing Ni and Li, in which the Ni content in the complex oxide is in the range of 70 to 100 mol % relative to the total molar number of constituent elements except Li and oxygen in the complex oxide. The positive electrode active material also contains Ni, Co, and Mn a part of which is replaced by Al, Ti, Zr, P, B, Si, Nb, C, or the like or particles with a surface covered with a compound containing Al, Ti, Zr, W, P, B, Si, Nb, C, or the like. The replacement amount and the addition amount are about 0.1 to 7% in total.

The negative electrode 24 typically includes a negative electrode current collector, and a negative electrode active material layer fixed on at least one surface of the negative electrode current collector. The negative electrode current collector has a band shape here. The negative electrode current collector is formed of a conductive metal such as copper, a copper alloy, nickel, or stainless steel. The negative electrode current collector is a metal foil here, specifically a copper foil.

The negative electrode active material layer is provided to have a band shape along a longitudinal direction of the negative electrode current collector with a band shape. The negative electrode active material layer includes a negative electrode active material that is capable of reversibly storing and releasing the charge carriers. As the negative electrode active material, for example, a carbon material such as graphite or carbon, a metal that can store lithium, such as Si, SiO, SiC, or Sn, and a compound thereof are given.

The separator is a member that insulates between the positive electrode active material layer and the negative electrode active material layer. As the separator, for example, a porous resin sheet made of a polyolefin resin such as polyethylene (PE) or polypropylene (PP) is preferable. On a surface of the separator, a heat resistance layer (HRL) including an inorganic filler may be provided. As the inorganic filler, for example, alumina, boehmite, aluminum hydroxide, titania, or the like can be used.

The electrolyte solution is accommodated inside the battery case 10 together with the electrode body 20. The electrolyte solution may be similar to that in the general secondary battery without particular limitations. The electrolyte solution is typically a nonaqueous liquid electrolyte (nonaqueous electrolyte solution) including a nonaqueous solvent and a supporting salt. Examples of the nonaqueous solvent include carbonates such as ethylene carbonate (EC), ethyl methyl carbonate (EMC), and dimethyl carbonate (DMC). The nonaqueous solvent is preferably formed by mixing EC, EMC, and DMC each within 1 to 99% so that the total ratio becomes 100%. The supporting salt is, for example, a fluorine-containing lithium salt. The fluorine-containing lithium salt preferably contains lithium hexafluorophosphate (LiPF₆), and lithium bis(fluorosulfonyl)imide (F₂LiNO₄S₂) called LiFSI, or a mixture thereof. The concentration of the supporting salt is preferably 0.6 to 1.8 mol per liter of the nonaqueous solvent.

The insulating film 50 is accommodated inside the battery case 10 together with the electrode body 20. The insulating film 50 is disposed between the battery case 10 and the electrode body 20. The insulating film 50 covers the periphery of the electrode body 20 as illustrated in FIG. 4. More specifically, it is preferable that the insulating film 50 cover at least the curved part facing the bottom surface 12a of the electrode body 20 and the pair of flat surfaces. The insulating film 50 is formed by one sheet-shaped member assembled into a box shape or a bag-like shape, for example.

FIG. 5 is a cross-sectional view illustrating a structure of the insulating film 50 according to one embodiment. The insulating film 50 includes a base material part 58 with an insulating property, and a first metal layer 51 and a second metal layer 52 that are embedded in the base material part 58. The first metal layer 51 and the second metal layer 52 are overlapped on each other in a stacking direction T from the electrode body 20 to the battery case 10. The insulating film 50 has a first surface 50a and a second surface 50b that are orthogonal to the stacking direction T. The first surface 50a is a surface facing the electrode body 20 and the second surface 50b is a surface facing the battery case 10.

At least the surface of the insulating film 50 that faces the battery case 10 and the surface thereof that faces the electrode body 20 are covered with an insulating material. Specifically, at least the first surface 50a and the second surface 50b of the insulating film 50 are each formed of the base material part 58. At the first surface 50a and the second surface 50b, neither the first metal layer 51 nor the second metal layer 52 is exposed. In this embodiment, both end parts of the insulating film 50 in a width direction W that is orthogonal to the stacking direction T are also covered with the base material part 58. In another embodiment, however, the first metal layer 51 and/or the second metal layer 52 may be exposed at the end parts in the width direction W in a part where the insulating film 50 is not in contact with the battery case 10 or the electrode body 20, for example.

In the embodiment in FIG. 5, the first metal layer 51 and the second metal layer 52 are in contact (direct contact) with each other in the stacking direction T. In another embodiment, however, the base material part 58 may exist between the first metal layer 51 and the second metal layer 52. Between the first metal layer 51 and the second metal layer 52, an adhesive layer or the like, which is different from the base material part 58, may exist instead of or in addition to the base material part 58, for example.

The first metal layer 51 is disposed on the electrode body 20 side relative to the second metal layer 52. Although there is no particular limitation, a thickness T1 (length in stacking direction T) of the first metal layer 51 is preferably 0.05 to 1.5 mm, more preferably 0.1 to 1 mm, and still more preferably 0.2 to 0.5 mm. When the thickness is more than or equal to a predetermined value, the effect of the art disclosed herein can be obtained at a high level. When the thickness is less than or equal to a predetermined value, the volume energy density can be improved.

The first metal layer 51 is formed of a first metal. The first metal is a metal or an alloy (two or more kinds of metals). The kind of the first metal is not limited in particular as long as the linear expansion coefficient is lower than that of a second metal to be described below. Although there is no particular limitation, the linear expansion coefficient of the first metal is preferably 23×10⁻⁶/K or less and for example, may be 0.1 to 22×10⁻⁶/K in consideration of the balance with the second metal. The linear expansion coefficient of the first metal is preferably lower than that of the metal of the battery case 10 (for example, aluminum).

The melting point of the first metal is preferably higher than that of the metal of the battery case 10 (for example, aluminum or aluminum alloy). Although there is no particular limitation, the melting point of the first metal is preferably 1000° C. or more, more preferably 1250° C. or more, and still more preferably 1400° C. or more. Thus, the effect of the art disclosed herein can be obtained at a high level. The melting point of the first metal may be 5000° C. or less, 4000° C. or less, or 2000° C. or less, for example, from the viewpoint of cost or the like. Specific examples of the first metal include copper, beryllium, nickel, iron, titanium, tungsten, stainless steel, carbon steel, nickel steel, duralumin, and the like, and titanium is particularly preferable.

The second metal layer 52 is disposed on the battery case 10 side relative to the first metal layer 51. Although there is no particular limitation, a thickness T2 (length in stacking direction T) of the second metal layer 52 is preferably 0.05 to 1.5 mm, more preferably 0.1 to 1 mm, and still more preferably 0.2 to 0.5 mm. When the thickness is more than or equal to a predetermined value, the effect of the art disclosed herein can be obtained at a high level. When the thickness is less than or equal to a predetermined value, the volume energy density can be improved. Although the thickness T2 of the second metal layer 52 is the same as the thickness T1 of the first metal layer 51 here, the first metal layer 51 and the second metal layer 52 may be different from each other in thickness in another embodiment.

The second metal layer 52 is formed of a second metal with a higher linear expansion coefficient than the first metal. The second metal is typically a metal or an alloy (two or more kinds of metals) that is different in kind from the first metal. The kind of the second metal is not limited in particular as long as the linear expansion coefficient is higher than that of the first metal. Although there is no particular limitation, the linear expansion coefficient of the second metal is preferably 5×10⁻⁶/K or more and more preferably 10×10⁻⁶/K or more and may be 14 to 25×10⁻⁶/K, for example, in consideration of the balance with the first metal. In addition, although there is no particular limitation, the difference in linear expansion coefficient between the first metal and the second metal ((linear expansion coefficient of second metal)-(linear expansion coefficient of first metal)) is preferably 1×10⁻⁶/K or more, more preferably 5×10⁻⁶/K or more, still more preferably 6×10⁻⁶/K or more, and particularly preferably 7×10⁻⁶/K or more. Thus, the effect of the art disclosed herein can be obtained at the high level.

The melting point of the second metal is typically lower than that of the first metal. Although there is no particular limitation, the melting point of the second metal is preferably 500° C. or more and more preferably 800° C. or more. Thus, the effect of the art disclosed herein can be obtained at the high level. The melting point of the second metal may be 2000° C. or less or 1500° C. or less. Specific examples of the second metal include aluminum, copper, brass, stainless steel, carbon steel, and the like, and copper is particularly preferable.

The base material part 58 is formed of an insulating material. The base material part 58 is typically formed of a material with the lower melting point than the first metal and the second metal. The base material part 58 is preferably formed of resin, and preferred examples thereof include olefin resins such as polyethylene (PE), polypropylene (PP/OPP), and polymethyl pentene (PMP/TPX (registered trademark)), polyester resins such as polyethylene terephthalate (PET) and polyethylene naphthalate (PEN), acrylic resin (PMMA), polyimide (PI), polyphenylene ether (PPE), triacetate (TAC), polyphenylene sulfide resin (PPS), polycarbonate (PC), nylon, fluorine resins such as polytetrafluoroethylene (PTFE), and the like. In particular, the olefin resin or engineering plastic with a heat resistance of 100° C. or more are preferable.

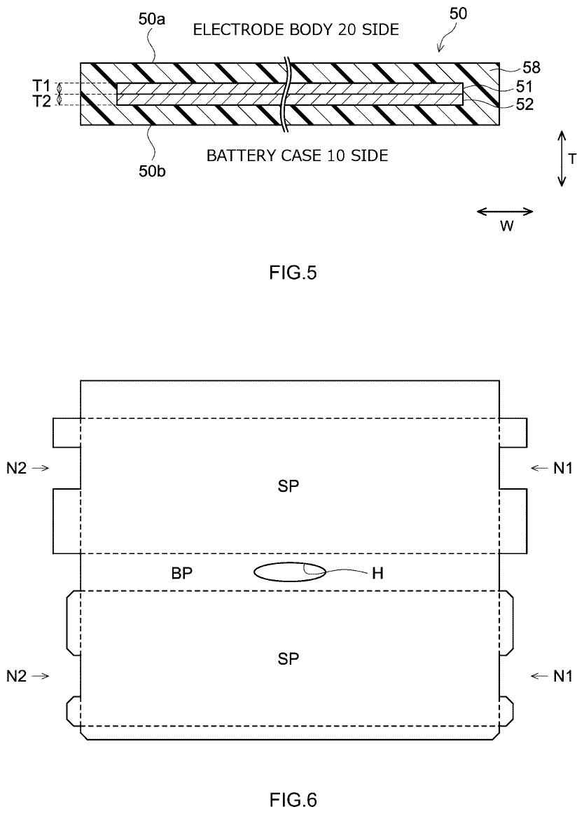

The insulating film 50 preferably includes a penetration hole H at a position facing the gas exhaust valve 13 (see FIG. 6). In another embodiment, however, the insulating film 50 does not need to have the penetration hole H. Alternatively, only a part of the insulating film 50 that faces the gas exhaust valve 13 may be formed of only a plastic film such as PP. In addition, the size of the penetration hole His arbitrarily determined. In a case where the gas exhaust valve 13 is an elliptical valve or a circular valve, the size of the penetration hole H is preferably about the outer edge of the gas exhaust valve 13±10 mm. In the case where the gas exhaust valve 13 is the notch as described in this embodiment, a part of the notch is preferably covered with the insulating film 50 in a part that faces the gas exhaust valve 13.

Even in the occurrence of an unsafe phenomenon in the battery case 10 due to, for example, overcharging or the like, the local heat concentration on the battery case 10 does not occur easily because the secondary battery 100 includes the insulating film 50. Specifically, since the linear expansion coefficient of the second metal included in the second metal layer 52 is higher than that of the first metal included in the first metal layer 51, when the fragment of the active material layer generated from the electrode body 20 in the battery case 10, for example, is in contact with the first metal layer 51 and heat conducts to the second metal layer 52, the second metal layer 52 expands more than the first metal layer 51. At this time, the heat also conducts along with the expansion, so that the heat can be diffused to the periphery. As a result, the local heat concentration on the battery case 10 can be suppressed and opening of the hole in the battery case 10 can be suppressed.

The insulating film 50 as described above can be manufactured by a manufacturing method including, for example, a preparing step S1 of preparing a film to be a raw material and a processing step S2 of processing the prepared film.

In the preparing step S1, for example, a metal plate (sheet shape with a thickness of about 0.5 to 3 mm) including the first metal (including alloy) and a metal plate (sheet shape with a thickness of about 0.5 to 3 mm) including the second metal are prepared and are each rolled with pressure into a foil with a predetermined thickness by metal roll pressing. Next, the obtained two metal foils (including alloy foils) are each cut into a predetermined size. The cutting method is not limited in particular; for example, the foils may be cut with a metal blade or a laser. A burr at the cut end part is preferably removed. Thus, in the insulating film 50, the end part of the metal does not penetrate the base material part 58 easily.

Next, an adhesive is applied individually to each of the two metal foils cut into the predetermined size, and the plastic films of the material as described above are crimped thereto from both surfaces. After that, the respective metal foils covered with the plastic films are overlapped on each other through the adhesive and crimped again, so that a film including the first metal layer 51 and the second metal layer 52 can be manufactured.

As a second method, alternatively, the two metal foils with the predetermined size are overlapped on each other first, and then the plastic film is crimped on the surfaces of the foils that do not face each other in accordance with a method similar to the aforementioned method, so that the film can be manufactured. At this time, the plastic film is preferably made larger than the metal foil so as to cover the two metal foils. After that, an unnecessary part of the plastic film is removed by cutting. At this time, an end surface of the metal foil will not be exposed at the cut end surface. Note that the cutting method is not limited in particular; for example, a metal blade or a laser may be used for the cutting.

As a third method, further alternatively, the plastic film of, for example, the olefin resin or various kinds of engineering plastics (PET, PEN, PI, PPE, fluorine resin film, etc.) is disposed on a metal foil with a predetermined size without using the adhesive, and heated at a high temperature of about 400° C. at maximum to melt and crimp the plastic, so that an integrated object of the metal foil and the plastic is manufactured. Then, the metal foil covered with the plastic film is overlapped on the surface of the manufactured integrated object and heated and melted again, so that the film can be manufactured.

As a fourth method, moreover, the two metal foils cut into predetermined different sizes are overlapped on each other and the plastic film is disposed on both surfaces of the respective foils that do not face each other, heated at a high temperature of about 400° C. at maximum to melt and crimp the plastic, so that a film can be manufactured. In this case, the plastic film also has the size that covers the entire metal foil. After that, an unnecessary part of the plastic film is removed by cutting in accordance with a method similar to the second method.

Next, in the processing step S2, for example, the film obtained as above is first cut into the shape and size along the outer shape of the electrode body 20. FIG. 6 is a development view of the insulating film 50 according to one embodiment. In FIG. 6, a bottom surface part BP is a part that faces a lower end part of the electrode body 20 and the bottom surface 12a of the battery case 10, and a side surface part SP is a part that faces the pair of flat surfaces of the electrode body 20 and the pair of long side surfaces 12b of the battery case 10. In addition, notch parts N1 and N2 correspond to a connection part (see FIG. 3) between the electrode body 20 and the positive electrode current collecting part 32 and a connection part (see FIG. 3) between the electrode body 20 and the negative electrode current collecting part 42, respectively. The insulating film 50 here has the penetration hole H at the bottom surface part BP. The penetration hole H is provided so that at least a part thereof faces the gas exhaust valve 13. The penetration hole H can be formed by removing the plastic film or the insulating film 50 in a part that faces the gas exhaust valve 13 by cutting. In addition, at a position of a dashed line, ruled line processing (for example, groove processing, perforating processing, or the like) may be performed for folding formation. By folding the film with such a shape along a dotted line, the insulating film 50 can be manufactured.

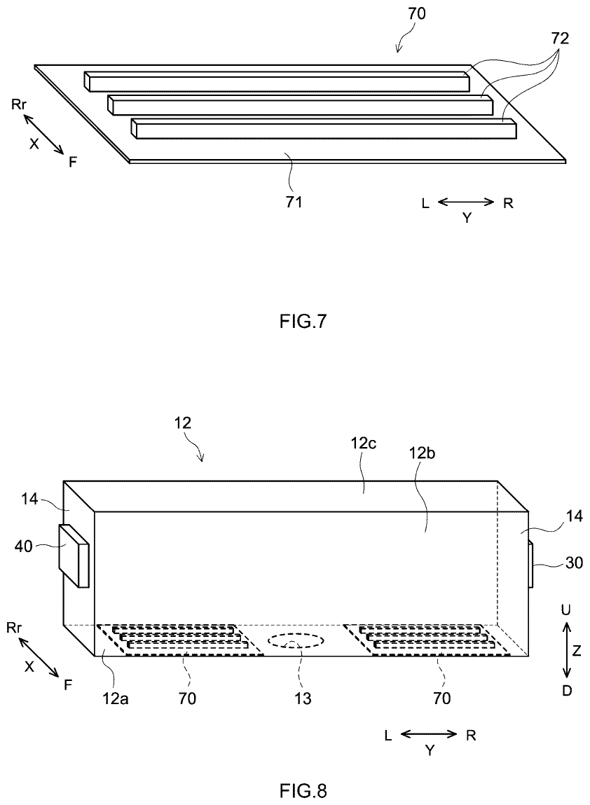

In some embodiments, the secondary battery 100 preferably further includes cooling plates 70 (see FIG. 7) each disposed between the battery case 10 and the electrode body 20 so as to be in contact with a part of the battery case 10 (for example, bottom surface 12a). The cooling plate 70 is preferably formed of a material with high thermal conductivity, and more preferably, for example, a metal material (including alloy material) mainly containing aluminum or a metal material mainly containing copper. The cooling plate 70 preferably has a surface thereof covered with resin such as polypropylene. By providing the cooling plate 70, the heat generated in the battery case 10 can be released efficiently and the safety of the secondary battery 100 can be improved. The cooling plate 70 is one example of “space formation part”.

FIG. 7 is a perspective view of the cooling plate 70 according to one embodiment. The cooling plate 70 according to this embodiment includes a base part 71 and a plurality of (here, three) protrusion parts 72. The base part 71 has a rectangular shape. The protrusion parts 72 are provided on a surface on the electrode body 20 side. The surface of the cooling plate 70 on the electrode body 20 side has an uneven shape. The protrusion part 72 has a rectangular columnar shape along the long side here. The number and shape (height, length, etc.) of protrusion parts 72 are not limited in particular and are determined arbitrarily.

FIG. 8 is a perspective view illustrating an arrangement example of the cooling plates 70. In this embodiment, the cooling plate 70 is in contact with the bottom surface 12a. The cooling plate 70 is disposed on the bottom surface 12a side of the electrode body 20, that is, between the bottom surface 12a and the electrode body 20 (not illustrated in FIG. 8). In another embodiment, however, the cooling plate 70 may be disposed on the long side surface 12b side, the top surface 12c side, or the sealing plate 14 side of the electrode body 20.

In this embodiment, the plurality of (in FIG. 8, two) cooling plates 70 are disposed in one battery case 10. The two cooling plates 70 are arranged in the long side direction Y so as to have the gas exhaust valve 13 therebetween. However, the number of cooling plates 70 to be disposed in one battery case 10 is not limited in particular and may be three or more, or one in another embodiment. For example, in the case where two gas exhaust valves 13 are provided on the bottom surface 12a, three cooling plates 70 may be arranged in the long side direction Y so as to have the two gas exhaust valves 13 therebetween. Alternatively, in the case where one, or two or more gas exhaust valves 13 are provided at a part of the battery case 10 other than the bottom surface 12a, for example provided on the long side surface 12b, the top surface 12c, or the sealing plate 14, one cooling plate 70 that is a little larger may be disposed on the bottom surface 12a.

The secondary battery 100 can be used for various applications, and can be suitably used, for example, as a power source (drive power source) for motors mounted on vehicles such as passenger cars and trucks. The vehicle is not limited to a particular type, and may be, for example, a plug-in hybrid electric vehicle (PHEV), a hybrid electric vehicle (HEV), or a battery electric vehicle (BEV).

Several Examples relating to the present disclosure will be explained below, but the present disclosure is not meant to be limited to these Examples.

### <Construction of Secondary Battery>

A metal plate (sheet shape with a thickness of about 0.5 to 3 mm) including the first metal and a metal plate (sheet shape with a thickness of about 0.5 to 3 mm) including the second metal shown in Table 1 were prepared and were each rolled into a foil with the thickness shown in Table 1 by metal roll pressing. Next, the two metal foils were cut into a predetermined size and overlapped on each other, and then a plastic film (PP) was disposed on each of surfaces of the respective foils that did not face each other. Note that the plastic film had the size that covered the entire metal foil (including end part). Next, this multilayer body was heated at a high temperature of about 400° C. at maximum to melt and moreover crimp the plastic, so that a film including the first metal layer and the second metal layer was obtained. Note that the properties (melting point, linear expansion coefficient) of the first metal and the second metal are as shown in Table 1. The difference in linear expansion coefficient was obtained by (linear expansion coefficient of second metal)-(linear expansion coefficient of first metal). In Comparative Example 1, only the PP film was used.

Next, the battery case in a cuboid shape with the gas exhaust valve was prepared. The position and number of gas exhaust valves are as shown in Table 1. Next, the film obtained as above was cut into a predetermined size and bent; thus, the insulating film was manufactured. In this case, in the example in which the penetration hole is “present” in Table 1, the penetration hole was provided at the position facing the gas exhaust valve. Specifically, at least a part of the metal foil in the part facing the gas exhaust valve was removed by cutting and the penetration hole was provided. Moreover, in the example in which the cooling plate is “present” in Table 1, the cooling plate was also prepared. Next, the electrode body was covered with the prepared insulating film. At this time, the first metal layer side was disposed to face the electrode body and the second metal layer side was disposed to face the battery case. Then, the electrode body covered with the insulating film was accommodated in the battery case, and the electrolyte solution was injected into the battery case; thus, the square secondary battery was manufactured as a sample.

### <Evaluation of Secondary Battery>

While the secondary battery manufactured as a sample was discharged, the secondary battery was held between metal blocks made of aluminum with a thickness of 3 cm through a heat insulating material or an elastic body from the long side surfaces on both sides, and restrained with a constant pressure of 0.1 to 1 MPa. Note that a hole of Φ several millimeters through which a needle can be inserted exists at a center of the metal block (at a position of a centroid (center) of the long side surface of the secondary battery). This hole has a hole diameter of about +1 to 2 mm relative to the diameter of the needle. For example, when the needle has a diameter of 3 mm, the hole diameter is about 3.1 to 3.2 mm. Next, the secondary battery held between the metal blocks was charged fully (SOC 100%). Then, a needle penetration test was performed in accordance with the following procedure.

In the needle penetration test, a predetermined needle was penetrated through the hole at the center of the metal block to forcibly short-circuit the secondary battery and the temperature of the secondary battery was increased. Note that the test temperature was room temperature (about 25° C.). As the needle, a round nail SIZE: N65 (ϕ3 mm, the shape is selected without angle regulation) manufactured by DAIDOHANT. CO., LTD. was used. The needle was penetrated at a speed of 1 mm/s and the needle penetration was stopped when the thermal runway of the secondary battery occurred.

Then, the mode change of the secondary battery after the thermal runaway was evaluated based on six ranks, from Rank 0 to Rank 5. The mode change of the secondary battery at each rank is as follows. The results are shown in Table 1.
Rank 0: a jetting substance was from the gas exhaust valve only, and the battery case did not change.
Rank 1: the jetting substance was from the gas exhaust valve and a cleavage in its periphery, and the battery case did not change beside this.
Rank 2: the jetting substance was from the gas exhaust valve, its periphery, and three or less other cleavages, and a cleavage was not formed at both terminal parts.
Rank 3: the jetting substance was from the gas exhaust valve, its periphery, and four to nine other cleavages, and a cleavage was not formed at both terminal parts.
Rank 4: the jetting substance was from the gas exhaust valve, its periphery, and ten or more other cleavages, and a cleavage was also formed at both terminal parts.
Rank 5: the jetting substance was from the gas exhaust valve, its periphery, and ten or more other cleavages, a cleavage was also formed at both terminal parts, and the surface of the terminal part was separated from the battery case.

TABLE 1

| | | Linear | | | | Linear | | |
|---|---|---|---|---|---|---|---|---|
| | | expansion | | | Kind of second | expansion | Melting | |
| | Kind of first metal | coefficient | Melting | Thickness | metal included | coefficient | point of | Thickness |
| | included in first | of first | point of | of first | in second | of second | second | of second |
| | metal layer | metal ×10⁻⁶/K | first metal | metal layer | metal layer | metal ×10⁻⁶/K | metal | metal layer |
| | (metal or alloy) | [20° C.] | (° C.) | (mm) | (metal or alloy) | [20° C.] | (° C.) | (mm) |
| Comparative | — (Only PP film) | — | — | — | — | — | — | — |
| Example 1 | | | | | | | | |
| Comparative | Aluminum (Al) | 23.1 | 666 | 0.2 | Aluminum (Al) | 23.1 | 666 | 0.2 |
| Example 2 | | | | | | | | |
| Comparative | Aluminum (Al) | 23.1 | 666 | 0.2 | Duralumin | 21.6 | 660 | 0.2 |
| Example 3 | | | | | (A2017) | | | |
| Example 1 | Duralumin | 21.6 | 660 | 0.2 | Aluminum (Al) | 23.1 | 666 | 0.2 |
| | (A2017) | | | | | | | |
| Example 2 | Copper (Cu) | 16.5 | 1085 | 0.2 | Brass (Cu 67%, | 17.5 | 800 | 0.2 |
| | | | | | Zn 33%) | | | |
| Example 3 | Beryllium (Be) | 11.4 | 1284 | 0.2 | Copper (Cu) | 16.5 | 1085 | 0.2 |
| Example 4 | Stainless steel | 14.7 | 1420 | 0.2 | Copper (Cu) | 16.5 | 1085 | 0.2 |
| | (SUS304) | | | | | | | |
| Example 5 | Nickel (Ni) | 13.4 | 1455 | 0.2 | Copper (Cu) | 16.5 | 1085 | 0.2 |
| Example 6 | Nickel (Ni) | 13.4 | 1455 | 0.2 | Stainless steel | 14.7 | 1420 | 0.2 |
| | | | | | (SUS304) | | | |
| Example 7 | Iron (Fe) | 11.8 | 1536 | 0.2 | Copper (Cu) | 16.5 | 1085 | 0.2 |
| Example 8 | Carbon steel | 10.7 | 1527 | 0.2 | Copper (Cu) | 16.5 | 1085 | 0.2 |
| | (Fe + C) | | | | | | | |
| Example 9 | Titanium (Ti) | 8.6 | 1666 | 0.2 | Copper (Cu) | 16.5 | 1085 | 0.2 |
| Example 10 | Titanium (Ti) | 8.6 | 1666 | 0.2 | Brass (Cu 67%, | 17.5 | 800 | 0.2 |
| | | | | | Zn 33%) | | | |
| Example 11 | Tungsten (W) | 4.5 | 3407 | 0.2 | Carbon steel | 10.7 | 1527 | 0.2 |
| | | | | | (Fe + C) | | | |
| Example 12 | Nickel steel | 0.13 | 1415 | 0.2 | Copper (Cu) | 16.5 | 1085 | 0.2 |
| | (Fe 64%, Ni 36%) | | | | | | | |
| Example 13 | Stainless steel | 14.7 | 1420 | 0.05 | Copper (Cu) | 16.5 | 1085 | 0.05 |
| | (SUS304) | | | | | | | |
| Example 14 | Stainless steel | 14.7 | 1420 | 0.1 | Copper (Cu) | 16.5 | 1085 | 0.1 |
| | (SUS304) | | | | | | | |
| Example 15 | Stainless steel | 14.7 | 1420 | 0.5 | Copper (Cu) | 16.5 | 1085 | 0.5 |
| | (SUS304) | | | | | | | |
| Example 16 | Stainless steel | 14.7 | 1420 | 1 | Copper (Cu) | 16.5 | 1085 | 1 |
| | (SUS304) | | | | | | | |
| Example 17 | Stainless steel | 14.7 | 1420 | 1.5 | Copper (Cu) | 16.5 | 1085 | 1.5 |
| | (SUS304) | | | | | | | |
| Example 18 | Titanium (Ti) | 8.6 | 1666 | 0.2 | Copper (Cu) | 16.5 | 1085 | 0.2 |
| Example 19 | Titanium (Ti) | 8.6 | 1666 | 0.2 | Copper (Cu) | 16.5 | 1085 | 0.2 |
| Example 20 | Titanium (Ti) | 8.6 | 1666 | 0.2 | Copper (Cu) | 16.5 | 1085 | 0.2 |

| | | | | | Presence or | |
|---|---|---|---|---|---|---|
| | | Presence or | | | absence of | |
| | Difference in linear | absence of | | | cooling plate | |
| | expansion coefficient | penetration | | The number of | between bottom | Evaluation |
| | between first | hole in film | Position of | gas exhaust | surface of | result |
| | metal and second | body facing | gas exhaust | valves of | battery case | Mode change |
| | metal ×10⁻⁶/K | gas exhaust | valve of | battery case | and electrode | of cell |
| | [20° C.] | valve | battery case | (pieces) | body | after test |
| Comparative | — | Absent | Bottom | 1 | Absent | Rank 5 |
| Example 1 | | | | | | |
| Comparative | 0 | Absent | Bottom | 1 | Absent | Rank 5 |
| Example 2 | | | | | | |
| Comparative | −1.5 | Absent | Bottom | 1 | Absent | Rank 5 |
| Example 3 | | | | | | |
| Example 1 | 1.5 | Absent | Bottom | 1 | Absent | Rank 4 |
| Example 2 | 1 | Absent | Bottom | 1 | Absent | Rank 3 |
| Example 3 | 5.1 | Absent | Bottom | 1 | Absent | Rank 2 |
| Example 4 | 1.8 | Absent | Bottom | 1 | Absent | Rank 3 |
| Example 5 | 3.1 | Absent | Bottom | 1 | Absent | Rank 3 |
| Example 6 | 1.3 | Absent | Bottom | 1 | Absent | Rank 3 |
| Example 7 | 4.7 | Absent | Bottom | 1 | Absent | Rank 3 |
| Example 8 | 5.8 | Absent | Bottom | 1 | Absent | Rank 2 |
| Example 9 | 7.9 | Absent | Bottom | 1 | Absent | Rank 1 |
| Example 10 | 8.9 | Absent | Bottom | 1 | Absent | Rank 1 |
| Example 11 | 6.2 | Absent | Bottom | 1 | Absent | Rank 0 |
| Example 12 | 16.37 | Absent | Bottom | 1 | Absent | Rank 0 |
| Example 13 | 1.8 | Absent | Bottom | 1 | Absent | Rank 4 |
| Example 14 | 1.8 | Absent | Bottom | 1 | Absent | Rank 4 |
| Example 15 | 1.8 | Absent | Bottom | 1 | Absent | Rank 3 |
| Example 16 | 1.8 | Absent | Bottom | 1 | Absent | Rank 2 |
| Example 17 | 1.8 | Absent | Bottom | 1 | Absent | Rank 1 |
| Example 18 | 7.9 | Present | Bottom | 1 | Absent | Rank 1 |
| Example 19 | 7.9 | Present | Left and right | 1 at each of | Absent | Rank 1 |
| | | | terminal sides | left and right | | |
| | | | | terminal sides | | |
| | | | | (2 in total) | | |
| Example 20 | 7.9 | Present | Left and right | 1 at each of | Present | Rank 0 |
| | | | terminal sides | left and right | | |
| | | | | terminal sides | | |
| | | | | (2 in total) | | |

As shown in Table 1, the insulating film formed of a polypropylene (PP) film with a thickness of about 0.4 mm was used in Comparative Example 1. In Comparative Example 2, the insulating film including two metal layers formed of aluminum (Al) with a thickness of about 0.2 mm was used. In Comparative Example 3, the insulating film including the first metal layer formed of aluminum (Al) with a thickness of about 0.2 mm and the second metal layer formed of alloy including duralumin (A2017) with a linear expansion coefficient lower than that of the first metal was used. In Comparative Examples 1 to 3, the mode change of the secondary battery after the thermal runaway was the largest and the state of Rank 5 was exhibited.

On the other hand, in Example 1, the insulating film including the first metal layer formed of alloy including duralumin (A2017) with a thickness of 0.2 mm and the second metal layer formed of aluminum (Al) with a linear expansion coefficient higher than that of the first metal was used. In Example 1, the mode change of the secondary battery after the thermal runaway was suppressed relatively compared to that in Comparative Examples 1 to 3, and the state of Rank 4 was exhibited. Although it is not intended to limit the interpretation in particular, the reasons are considered as follows. Since the linear expansion coefficient of the second metal is higher than that of the first metal (alloy), the contact of the jetting substance generated from the electrode body inside the battery with the first metal layer causes the second metal layer to expand more largely than the first metal layer. Along with the expansion, the heat also transfers and accordingly, the heat can be diffused more to the periphery. As a result, the heat concentration on the battery case in contact with this part is suppressed and the hole is opened less easily in the battery case.

In Example 2, the insulating film including the first metal layer formed of copper (Cu) with a thickness of 0.2 mm and the second metal layer formed of alloy including brass (Cu 67%, Zn 33%) with a linear expansion coefficient higher than that of the first metal was used. In Example 1, the mode change of the secondary battery after the thermal runaway was suppressed more compared to that in Comparative Examples 1 to 3 and Example 1, and the state of Rank 3 was exhibited. Although it is not intended to limit the interpretation in particular, the reason is considered that the melting point of the first metal is higher than that in Example 1. That is to say, if the melting point of the first metal is high, it takes long to diffuse the heat before melting, so that the amount of heat that concentrates on the battery case was able to be reduced effectively.

In Example 3, the insulating film including the first metal layer formed of beryllium (Be) with a thickness of 0.2 mm and the second metal layer formed of copper with a linear expansion coefficient higher than that of the first metal was used. In Example 3, the mode change of the secondary battery after the thermal runaway was suppressed further compared to that in Comparative Examples 1 to 3 and Examples 1 and 2, and the state of Rank 2 was exhibited. Although it is not intended to limit the interpretation in particular, the reason is considered as follows: the melting point of the first metal is higher than that in Example 1 and moreover, the difference in linear expansion coefficient between the first metal and the second metal is large. That is to say, when the difference in linear expansion coefficient between the first metal and the second metal is larger, the heat diffusion effect by the second metal becomes higher; accordingly, the heat concentration on the battery case is considered to be suppressed more.

In Examples 4 to 12, the kind of the first metal and/or the second metal is different. The results in Examples 4 to 12 indicate that the mode change of the secondary battery after the thermal runaway is suppressed more and the better result (higher rank) tends to be obtained as the melting point of the first metal is higher and the difference in linear expansion coefficient between the first metal and the second metal is larger.

In Examples 13 to 17, the first metal layer and the second metal layer are different in thickness. When the thickness of each metal layer was less than 0.05 mm, the film thickness uniformity was poor and the manufacture was difficult. On the other hand, when the thickness of each metal layer was more than 1.5 mm, the total amount reduction of the electrode body to be disposed in the battery case was increased, which resulted in the battery capacity reduction. Accordingly, the thickness of each of the first metal layer and the second metal layer is preferably in the range of 0.05 to 1.5 mm, and the results from Examples 13 to 17 indicate that, in this range, the mode change of the second battery after the thermal runaway was suppressed more and the better result (higher rank) was obtained when the thickness was larger.

Example 18 is similar to Example 9 except that the penetration hole is provided at the position in the insulating film that faces the gas exhaust valve. Examples 9 and 18 indicate that the mode change of the secondary battery after the thermal runaway was suppressed at the high level and the favorable result (Rank 1) was obtained.

Example 20 is similar to Example 19 except that the cooling plate is provided between the bottom surface of the battery case and the electrode body. The comparison between Examples 19 and 20 indicates that the mode change of the second battery after the thermal runaway was suppressed more and the better result was obtained (rank was improved from 1 to 0) as the heat dissipation was improved.

The embodiments of the art disclosed herein has been described above; however, these are just examples and will not limit the scope of claims. The art described in the scope of claims includes those in which the specific examples given above are variously modified and changed.

As described above, the following items are given as specific aspects of the art disclosed herein.
Item 1: The secondary battery including the battery case, the electrode body that is accommodated in the battery case, and the insulating film that is disposed between the battery case and the electrode body, in which the insulating film includes the first metal layer formed of the first metal and the second metal layer disposed on the side of the battery case relative to the first metal layer and formed of the second metal with the linear expansion coefficient higher than that of the first metal, and at least the surface of the insulating film that faces the battery case and the surface of the insulating film that faces the electrode body are covered with the insulating material.
Item 2: The secondary battery according to Item 1, in which the battery case is formed of metal, and the melting point of the first metal is higher than the melting point of the metal included in the battery case.
Item 3: The secondary battery according to Item 1 or 2, in which the first metal has a melting point of 1250° C. or more.
Item 4: The secondary battery according to any one of Items 1 to 3, in which the first metal has a melting point of 1400° C. or more.
Item 5: The secondary battery according to any one of Items 1 to 4, in which the difference in linear expansion coefficient between the first metal and the second metal is 5/K or more.
Item 6: The secondary battery according to any one of Items 1 to 5, in which the first metal layer has a thickness of 0.05 mm or more and 1.5 mm or less.
Item 7: The secondary battery according to any one of Items 1 to 6, in which the second metal layer has a thickness of 0.05 mm or more and 1.5 mm or less.
Item 8: The secondary battery according to any one of Items 1 to 7, in which the battery case includes the gas exhaust valve, and the insulating film includes the penetration hole at the position facing the gas exhaust valve.
Item 9: The secondary battery according to Item 8, in which the battery case includes the case main body that includes the bottom surface, the side surface, and the opening, and the sealing plate that seals the opening, and the gas exhaust valve is provided on the bottom surface.
Item 10: The secondary battery according to Item 9, further including the space formation part that is disposed between the bottom surface and the electrode body and has the surface with the uneven shape on the side facing the electrode body.

### REFERENCE SIGNS LIST

10 Battery case
12 Case main body
12a Bottom surface
13 Gas exhaust valve
14 Sealing plate
20 Electrode body
50 Insulating film
51 First metal layer
52 Second metal layer
58 Base material part
70 Cooling plate (space formation part)
100 Secondary battery

What is claimed is:

1. A secondary battery comprising a battery case, an electrode body that is accommodated in the battery case, and an insulating film that is disposed between the battery case and the electrode body, wherein
the insulating film includes a first metal layer formed of a first metal and a second metal layer disposed on a side of the battery case relative to the first metal layer and formed of a second metal with a linear expansion coefficient higher than that of the first metal, and at least a surface of the insulating film that faces the battery case and a surface of the insulating film that faces the electrode body are covered with an insulating material.

2. The secondary battery according to claim 1, wherein
the battery case is formed of metal, and
a melting point of the first metal is higher than a melting point of the metal included in the battery case.

3. The secondary battery according to claim 1, wherein the first metal has a melting point of 1250° C. or more.

4. The secondary battery according to claim 1, wherein the first metal has a melting point of 1400° C. or more.

5. The secondary battery according to claim 1, wherein a difference in linear expansion coefficient between the first metal and the second metal is 5/K or more.

6. The secondary battery according to claim 1, wherein the first metal layer has a thickness of 0.05 mm or more and 1.5 mm or less.

7. The secondary battery according to claim 1, wherein the second metal layer has a thickness of 0.05 mm or more and 1.5 mm or less.

8. The secondary battery according to claim 1, wherein
the battery case includes a gas exhaust valve, and
the insulating film includes a penetration hole at a position facing the gas exhaust valve.

9. The secondary battery according to claim 8, wherein
the battery case includes a case main body that includes a bottom surface, a side surface, and an opening, and a sealing plate that seals the opening, and
the gas exhaust valve is provided on the bottom surface.

10. The secondary battery according to claim 9, further comprising a space formation part that is disposed between the bottom surface and the electrode body and has a surface with an uneven shape on a side facing the electrode body.
